(19) United States
(12) Patent Application Publication
(10) Pub. No.: US 2020/0107544 A1
(43) Pub. Date: Apr. 9, 2020

(54) Methods For Repelling Blood-Sucking And Biting Insects, Ticks And Mites

(71) Applicant: The United States of America, as Represented by the Secretary of Agriculture, Washington, DC (US)

(72) Inventors: Junwei J. Zhu, Lincoln, NE (US); Steven C. Cermak, Peoria, IL (US)

(21) Appl. No.: 16/704,028

(22) Filed: Dec. 5, 2019

Related U.S. Application Data
(63) Continuation of application No. 15/980,094, filed on May 15, 2018.
(60) Provisional application No. 62/506,788, filed on May 16, 2017.

(51) Int. Cl. A01N 37/02; A01N 37/06

(52) U.S. Cl. CPC A01N 37/02; A01N 37/06

(57) ABSTRACT

Methods for repelling or killing insects, said method comprising treating an object or area with a composition comprising an insects repelling or killing effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid, and mixtures thereof, and optionally a carrier. The term “insects” as used herein includes non-insects such as ticks, mites, spiders, centipedes, scorpions, chiggers, and solifugids.

### REFERENCE TO RELATED APPLICATION

This application claims the benefit of U.S. Provisional Application No. 62/506,788, filed 16 May 2017, which is incorporated herein by reference in its entirety.

### BACKGROUND OF THE INVENTION

Disclosed are methods for repelling or killing insects, involving treating an object or area with a composition comprising an insects repelling or killing effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid (e.g., calcium, sodium, magnesium, potassium), and mixtures thereof, and optionally a carrier. The term “insects” as used herein includes non-insects such as ticks, mites, spiders, centipedes, scorpions, chiggers, and solifugids.

Stable flies (Stomoxys calcitran) and horn flies (Haematobia irritans) are two examples of major blood-feeding pests of bovids and equids in confined and pasture settings (Zumpt, F., The Stomoxyine Biting Flies of the World, Gustav Fisher Verlag, Stuttgart, Germany, 1973, pp 1-175; Byford, R. L., et al., J. Animal Science, 70: 597-602 (1992)). It has been reported that just stable flies alone can cause over $2 billion annually in losses to the U.S. cattle industry (Taylor, D. B., et al., Medical & Veterinary Entomology, 49: 198-209 (2012); Kunz, S. E., et al., Estimated losses of livestock pests, pages 68-69, IN: Pimentel, D., ed., Handbook of pest management in agriculture, 1991, CRC Press, Boca Raton, Fla.). These flies can be serious pests of humans and companion animals as well when their primary hosts are absent. The horn fly is also a vector of several pathogens, such as several Staphylococcus spp. bacteria which cause mastitis or infection of the teats in dairy cows (Edwards, J. F., et al., Vet. Pathol., 37:360-364 (2012); Oliver, S. P., et al., Intern. J. Appl. Res. Vet. Med., 3:150-162 (1991)). Biting fly control in confined and pastured livestock settings has focused primarily on sanitation and insecticides. However, sanitation procedures are costly, and insecticides provide only marginal control. Recently, several field populations of the both fly species were identified as being resistant to permethrin, the most commonly used insecticide for stable fly management (Cilek, J. E., and G. L. Greene, J. Econ. Entomol., 87: 275-279 (1999); Pitzer, J. B., et al., J. Econ. Entomol., 103: 2258-2263 (2010); Somme, L., J. Econ. Entomol., 51: 599-601 (1985)).

The use of repellents is considered as one of the most effective tools for protecting humans from biting insects, particularly mosquitoes (Isman, M. B., Ann. Rev. Entomol., 51: 45-66 (2006)). Recent studies have demonstrated the effectiveness of botanical-based repellents as alternatives against dipteran blood-sucking flies (Zhu, J. J., et al., Med. Vet. Entomol., 23: 209-216 (2009); Watson, W., et al., Insect repellents in the management of horn flies, IN: Proceedings of the 6th Mid-Atlantic Dairy Grazing Conference, Oct. 31-Nov. 2006, 1, Goldsboro, N.C., p. 67; Mullens, B. A., et al., Pest. Manag. Sci., 65: 1360-1366 (2009)). The use of repellents could be an effective alternative strategy for reducing the impact of stable flies and other insect pests on livestock.

Herein we disclose new insect repellants effectively against insects such as stable flies and horn flies, as well as other insects, such as bedbugs (Cimex letularius) and also ticks (Amblyomma americanum and Rhipicephalus sanguineus). Also disclosed are insecticides.

### SUMMARY OF THE INVENTION

Disclosed are methods for repelling or killing insects, involving treating an object or area with a composition comprising an insects repelling or killing effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid (e.g., calcium, sodium, magnesium, potassium), and mixtures thereof, and optionally a carrier. The term “insects” as used herein includes non-insects such as ticks, mites, spiders, centipedes, scorpions, chiggers, and solifugids.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows GC spectrum of free fatty acids (FFA), after being converted to their methyl esters, from the hydrolyzed coconut oil as described below. The relative amounts of FFA are listed in Table 1.

FIG. 2 shows repellency efficacy comparisons from coconut oil, hydrolyzed coconut oil (coconut FFA) and its major ingredient (lauric acid) and corresponding methyl ester derivative as described below.

FIG. 3 shows comparisons of repellency of saturated fatty acids from C8 to C18 as described below.

FIG. 4 shows dose response curves of repellency from coconut FFA, lauric acid and catnip oil as described below (dashed line indicates the blood-fed from controls).

FIG. 5 shows longevity test of repellency from coconut FFA, lauric acid and catnip oil as described below (dashed line indicates the blood-fed from controls).

FIG. 6 shows comparisons of percentiles of blood feeding of stable flies while treated with coconut FFA and with different combinations of the three active repellent fatty acids from hydrolyzed coconut oil (C8:C10:C12=10.25:10.96:78.79; C8:C12=11.5:88.5; C10:C12=12.2:87.8; C8:C10=48.3:51.7) as described below.

FIG. 7 shows comparisons of repellency from coconut FFA, lauric acid and methyl laurate against horn flies as described below.

FIG. 8 shows dose-response curves of repellency from coconut FFA and lauric acid against horn flies as described below.

FIG. 9A, FIG. 9B, FIG. 9C, FIG. 9D, and FIG. 9E show laboratory bioassays showing significant repellency from coconut FFA or DEET against bed bugs as described below.

FIG. 10 shows dose responses of repellency and longevity tests from coconut oil fatty acids against two tick species as described below. Different letters inside bars (red) indicate significant differences among three doses tested.

FIG. 11 shows mean percentages of blood feeding of stable flies with treatments of saturated C8-C16 methyl esters and C18 Me (methyl oleate) as described below.

FIG. 12 shows mean percentages of blood feeding of stable flies with treatments of C8-C12 methyl esters at three doses as described below.

FIG. 13 shows mean knock-down time (mins) of stable flies with treatments of C8-C12 methyl esters at three doses as described below.

FIG. 14 shows mortality observed (measured minutes after exposure) of stable flies with treatments of C8-C12 methyl esters at three doses as described below.

### DETAILED DESCRIPTION OF THE INVENTION

Disclosed are methods for repelling or killing insects, involving treating an object or area with a composition comprising an insects repelling or killing effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid (e.g., calcium, sodium, magnesium, potassium), and mixtures thereof, and optionally a carrier. The term “insects” as used herein includes non-insects such as ticks, mites, spiders, centipedes, scorpions, chiggers, and solifugids.

The present invention discloses a blood-sucking insects and biting insects (e.g., stable flies, horn flies, ticks and mites repellent compounds (e.g., lauric acid), identified from coconut oil that is listed as a GRAS (Generally Recognized as Safe, http://www.fda.gov/Food/IngredientsPackagingLabeling/GRAS/) substance. Coconut oil is an edible oil extracted from the kernel or meat of mature coconuts harvested from the coconut palm (https://en.wikipedia.org/wiki/Coconut_oil). It contains a high level of low molecular weight saturated fatty acids (Gervajio, G. C., Fatty acids and derivatives from coconut oil, IN: Bailey's Industrial Oil and Fat Products, Sixth Edition, Six Volume Set, Fereidoon Shahidi, Ed., 2005, John Wiley & Sons, Inc.). Chemical analyses show that coconut oil contains a majority of medium chain fatty acids, with around 50% being lauric acid. Our laboratory repellent screening assays showed over 90% repellency from the application of lauric acid, as well as the hydrolyzed coconut oil free fatty acid (coconut FFA) at a 20 mg dosage against stable flies. Both have over 2-weeks longevity deterring stable fly feeding (>90% repellency). During these lab assays, we further observed from one of its derivatives, methyl laurate (via transesterification of lauric acid), not only surprisingly had a similar level of repellency as lauric acid, but unexpectedly also exhibited relatively strong toxicity (100% mortality observed in 15-20 mins against both biting flies after exposure to methyl laurate). This compound is listed as one of CFR 21 products that is permitted for direct addition to food for human consumption by FDA (Code of Federal Regulations, Title 21). The identified new fly repellent compound, lauric acid, can be replaced with industry mass-produced low-cost coconut free fatty acids containing lauric acid (<$0.7/pound, based on the bulk price from, for example, ACME HARDESTY for Coconut Oil Fatty Acids or Palm Kernel Oil Fatty Acids (CAS#:61788-47-4; 67701-05-7; 101403-98-9; which contain about 0.5% max C6, 4-8% C8, 5-10% C10, 46-53% C12, 15-21% C14, 5-13% C16, 4% max C18, 5-12% C18:1, and 3% max C18:2)). Lauric acid, methyl laurate, and coconut free fatty acids can be used as a sprayable repellent formulation that can be well accepted by livestock producers due to their longer effective time and extremely lower cost ($0.038 per application of coconut free fatty acids per animal). Palm kernel oil and cuphea oil are very similar to coconut oil.

We also tested the repellency against other blood-sucking insects, such as bedbugs (100% repellency at 5% of lauric acid with effectiveness up to 24 hours), ticks (100% repellency at 1.25% from coconut FFA and methyl laurate), and mosquitoes (minimum effective dosage at 0.75 mg/cm² from lauric acid and 0.5 mg/cm² from coconut FFA against Aedes aegypti (table 4); while applied at a dosage of 25% coconut FFA, equal repellent efficacy was observed compared to DEET (same concentration) as well. Thus our results have demonstrated their strong repellency against other blood-sucking insects as well.

The terms “object” or “area” as used herein include any place where the presence of target pests (e.g., stable flies (Stomoxys calcitran) and horn flies (Haematobia irritans)) is not desirable, including any type of premises, which can be out-of-doors, such as in gardens, lawns, tents, camping bed nets, camping areas, and so forth, or indoors, such as in barns, garages, commercial buildings, homes, and so forth, or any area where pests are a problem, such as in shipping or storage containers (e.g., bags, boxes, crates, etc.), packing materials, bedding, and so forth; also includes the outer covering of a living being, such as skin, fur, hair, or clothing. Thus the method includes dispensing the compounds described herein into the environment in vapor form (e.g., an aerosol) preferably using devices that allow a slow sustained release of these compounds into the environment from a sealed canister.

Disclosed herein are methods for repelling insects (the term “insects” as used herein includes non-insects such as ticks, mites, spiders, centipedes, scorpions, chiggers, and solifugids) involving treating an object or area with an insect repelling effective amount of a composition containing the compounds disclosed herein and optionally a carrier (e.g., agronomically or physiologically or pharmaceutically acceptable carrier). The carrier component can be a liquid or a solid material. The term “carrier” as used herein includes carrier materials such as those described below. As is known in the art, the vehicle or carrier to be used refers to a substrate such as a mineral oil, paraffin, silicon oil, water, membrane, sachets, disks, rope, vials, tubes, septa, resin, hollow fiber, microcapsule, cigarette filter, gel, fiber, natural and/or synthetic polymers, elastomers or the like. All of these substrates have been used to controlled release effective amount of a composition containing the compounds disclosed herein in general and are well known in the art. Suitable carriers are well-known in the art and are selected in accordance with the ultimate application of interest. Agronomically acceptable substances include aqueous solutions, glycols, alcohols, ketones, esters, hydrocarbons halogenated hydrocarbons, polyvinyl chloride; in addition, solid carriers such as clays, laminates, cellulosic and rubber matrices and synthetic polymer of biopolymer matrices, or the like.

The amount of the repellant compounds described herein or compositions described herein to be used will be at least an effective amount. The term “effective amount,” as used herein, means the minimum amount of the compounds or compositions needed to repel the insects, ticks and mites when compared to the same area or object which is untreated. Of course, the precise amount needed will vary in accordance with the particular composition used; the type of area or object to be treated; and the environment in which the area or object is located. The precise amount of the composition can easily be determined by one skilled in the art given the teaching of this application. For example, one skilled in the art could follow the procedures utilized below; the composition would be statistically significant in comparison to a negative control. The compounds described herein or compositions described herein to be used will be at least an effective amount of the compound or diluted solution of the compound. Generally the concentration of the compounds will be, but not limited to, about 0.025% to about 10% (e.g., 0.025 to 10%, for example in an aqueous solution), preferably about 0.5% to about 4% (e.g., 0.5 to 4%), more preferably about 1% to about 2% (e.g., 1 to 2%). The composition may or may not contain a control agent for insects, such as a biological control agent or an insecticide known in the art to kill insects. Other compounds (e.g., insecticides known in the art) may be added to the composition provided they do not substantially interfere with the intended activity and efficacy of the composition; whether or not a compound interferes with activity and/or efficacy can be determined, for example, by the procedures utilized below.

The compositions and compounds can be used for repelling harmful or troublesome blood-sucking insects and biting insects, ticks and mites including mosquitoes (for example Aedes, Culex and Anopheles species including but not limited to Tiger mosquitoes, Aedes aboriginis, Aedes aegypti, Aedes albopictus, Aedes cantator, Aedes sierrensis, Aedes sollicitans, Aedes squamiger, Aedes sticticus, Aedes vexans, Anopheles quadrimaculatus, Culex pipiens, and Culex quinquefasciatus), sand flies (for example Phlebotomus and Lutzomyia species), bed bugs (for example Cimex lectularius), owl gnats (Phlebotoma), blackfly (Culicoides species), buffalo gnats (Simulium species), biting flies (for example Stomoxys calcitrans), tsetse flies (Glossina species), horseflies (Tabanus, Haematopota and Chrysops species), house flies (for example Musca domestica and Fannia canicularis), meat flies (for example Sarcophaga carnaria), flies which cause myiasis (for example Lucilia cuprina, Chrysomyia chloropyga, Hypoderma bovis, Hypoderma lineatum, Dermatobia hominis, Oestrus ovis, Gasterophilus intestinalis and Cochliomyia hominovorax), bugs (for example Cimex lectularius, Rhodnius prolixus and Triatoma infestans), lice (for example Pediculus humanus, Haematopinus suis and Damalina ovis), louse flies (for example Melaphagus orinus), and fleas (for example Pulex irritans, Cthenocephalides canis and Xenopsylla cheopis), sand fleas (for example Dermatophilus penetrans), and blood-feeding ticks (for example Ornithodorus moubata, Ixodes ricinus, Ixodes scapularis, Boophilus microplus, Amblyomma americanum, and Amblyomma hebreum), and mites (for example Sarcoptes scabiei and Dermanyssus gallinae).

Blood-sucking insects include mosquitoes (for example Aedes, Culex and Anopheles species), sand flies (for example Phlebotomus and Lutzomyia species such as Phlebotomus papatasi), owl gnats (Phlebotoma), blackfly (Culicoides species), buffalo gnats (Simulium species), biting flies (for example Stomoxys calcitrans), tsetse flies (Glossina species), horseflies (Tabanus, Haematopota and Chrysops species), house flies (for example Musca domestica and Fannia canicularis), meat flies (for example Sarcophaga carnaria), flies which cause myiasis (for example Lucilia cuprina, Chrysomyia chloropyga, Hypoderma bovis, Hypoderma lineatum, Dermatobia hominis, Oestrus ovis, Gasterophilus intestinalis and Cochliomyia hominovorax), bugs (for example Cimex lectularius, Rhodnius prolixus and Triatoma infestans), lice (for example Pediculus humanus, Haematopinus suis and Damalina ovis), louse flies (for example Melaphagus orinus), fleas (for example Pulex irritans, Cthenocephalides canis and Xenopsylla cheopis) and sand fleas (for example Dermatophilus penetrans).

Biting insects include cockroaches (for example Blattella germanica, Periplaneta americana, Blatta orientalis and Supella supellectilium), beetles (for example Sitophilus granarius, Tenebrio molitor, Dermestes lardarius, Stegobium paniceum, Anobium puntactum and Hylotrupes bajulus), termites (for example Reticulitermes lucifugus), bed bug (for example Cimex lectularius) and ants (for example Lasius niger).

Ticks include, for example, Ornithodorus moubata, Ixodes ricinus, Boophilus microplus and Amblyomma hebreum, and mites include, for example, Varroa destructor, Sarcoptes scabiei, Dermanyssus gallinae, Tetranychus urticae, Tetranychus cinnabarinus, and Oligonychus pratensis.

Spiders include, for example, Lactrodectus mactans, Loxosceles recluse, Tegenaria agrestis (Walckenaer), Achaearanea tepidariorum, Salticidae, Pholcus phalangioides, and Lycosa.

Centipedes include, for example, Scutigera coleoptrata.

Scorpions include, for example, Centruroides exilicauda, Centruroides vittatus, Hadrurus arizonensis, and Solifugae.

Solifugids include, for example, Solifugae.

The compositions (e.g., methyl laurate) can also be used for killing insects such as harmful or troublesome blood-sucking, stinging and biting insects, ticks and mites (the term “insects” as used herein includes non-insects such as ticks, mites, spiders, centipedes, scorpions, chiggers, and solifugids). The amount of the compounds described herein or compositions described herein to be used will be at least an effective amount. The term “effective amount,” as used herein, means the minimum amount of the compounds or compositions needed to kill the insects, ticks and mites when compared to the same area or object which is untreated. Of course, the precise amount needed will vary in accordance with the particular composition used; the type of area or object to be treated; and the environment in which the area or object is located. The precise amount of the composition can easily be determined by one skilled in the art given the teaching of this application. For example, one skilled in the art could follow the procedures utilized below; the composition would be statistically significant in comparison to a negative control. The compounds described herein or compositions described herein to be used will be at least an effective amount of the compound or diluted solution of the compound; for fumigation the compounds used may have to be pure form (not mixed or adulterated with any other substance or material). Generally the concentration of the compounds will be, but not limited to, about 0.025% to about 10% (e.g., 0.025 to 10%, for example in an aqueous solution), preferably about 0.5% to about 4% (e.g., 0.5 to 4%), more preferably about 1% to about 2% (e.g., 1 to 2%). The composition may or may not contain a control agent for insects, such as a biological control agent or an insecticide known in the art to kill insects. Other compounds (e.g., insect attractants or other insecticides known in the art) may be added to the composition provided they do not substantially interfere with the intended activity and efficacy of the composition; whether or not a compound interferes with activity and/or efficacy can be determined, for example, by the procedures utilized below.

The compositions can therefore be used for killing insects such as harmful or troublesome blood-sucking, stinging and biting insects, ticks and mites. The term “insects” as used herein include all stages of insect life cycle: adults, larvae, nymphs, pupae, and eggs.

The compounds, which can be used in undiluted or diluted form, can be converted into formulations customary for repellents. They can be used in all the presentation forms customary in cosmetics and public health pesticides, for example in the form of solutions, emulsions, gels, ointments, pastes, creams, powders, sticks, sprays or aerosols from spray cans.

For use in the non-cosmetic sector, the compounds can be incorporated, for example, into granules, oily spraying agents or slow release formulations.

The formulations are prepared in a known manner by mixing or diluting the compounds with solvents (for example xylene, chlorobenzenes, paraffins, methanol, ethanol, isopropanol or water), carriers (for example kaolins, aluminas, talc, chalk, highly disperse silicic acid and silicates, nanoclays), emulsifying agents (for example polyoxyethylene fatty acid esters, polyoxyethylene fatty alcohol ethers, alkylsulphonates and arylsulphonates) and dispersing agents (for example lignin, sulphite waste liquors and methylcellulose).

The compounds can be included in starch-oil compositions (e.g., U.S. Pat. Nos. 5,676,994 and 5,882,713) or starch-oil dispersions (e.g., U.S. Pat. No. 7,875,262).

The compounds can be mixed with one another in the formulations or can also be used as mixtures with other known active or inactive compounds. The formulations in general contain between about 0.1 and about 95% (e.g., 0.1-95%) by weight of active compound, preferably between about 0.5 and about 90% (e.g., 0.5-90%). Other compounds may be added to the composition provided they do not substantially interfere with the intended activity and efficacy of the composition; whether or not a compound interferes with activity and/or efficacy can be determined, for example, by the procedures utilized below.

For protection from insects, ticks and mites, the compounds are generally either applied to human or animal skin, or items of clothing and other objects are treated with the compounds. Preferably, the compounds are dispensed into the environment (e.g., outdoors or indoors) in their natural state (optionally with a carrier) or in vapor form (e.g., an aerosol).

The compounds are also suitable as an additive to impregnating agents, for example, textile webs, articles of clothing and packaging materials, and as an additive to polishing, cleaning and window-cleaning agents.

The compositions contain a carrier and the compound. The repellent is generally applied with a carrier component. The carrier component can be a gas, liquid or a solid material. As is known in the art, the vehicle or carrier to be used refers to a substrate such as a gel, polymers, or the like. All of these substrates have been used to release insect repellents and are well known in the art. The carrier or carrier material as used herein is defined as not including an insect, tick, or mite.

The compounds herein are described as repellents because they result in a reduction in the ability of insects, ticks and mites to locate a host, and thus reduce the incidence of biting. Generally, an insect, tick and mite repellant is any compound or composition which deters insects, ticks and mites from a host, thus the term “repelling” is defined as causing insects (e.g., stable flies (Stomoxys calcitran) and horn flies (Haematobia irritans)), ticks and mites to make oriented movements away from a source of a chemical repellent (Dethier, V. L., et al., J. Econ. Ent., 53: 134-136 (1960)) but also includes inhibiting feeding by insects, ticks and mites when a chemical is present in a place where insects, ticks and mites would, in the absence of the chemical, feed. Thus the term “repelling” also includes reducing the number of insect (e.g., stable flies (Stomoxys calcitran) and horn flies (Haematobia irritans)), tick and mite bites on a treated area (e.g., barns, pastures) or object (e.g., primary host livestock, humans, companion animals; mammalian skin which has been treated topically with the compositions or compounds) when compared to the same area or object which is untreated.

“Optional” or “optionally” means that the subsequently described event or circumstance may or may not occur, and that the description includes instances in which said event or circumstance occurs and instances where it does not. For example, the phrase “optionally comprising an insecticide” means that the composition may or may not contain an insecticide and that this description includes compositions that contain and do not contain an insecticide.

Compositions containing one or more (e.g., two) of the compounds described herein may contain one specific compound or may not contain that specific compound. For example, a composition could contain lauric acid, or the composition may not contain lauric acid. Another example, a composition could contain lauric acid and methyl laurate, or the composition may not contain methyl laurate.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments and characteristics described herein and/or incorporated herein. In addition, the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much 10% to a reference quantity, level, value, or amount.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

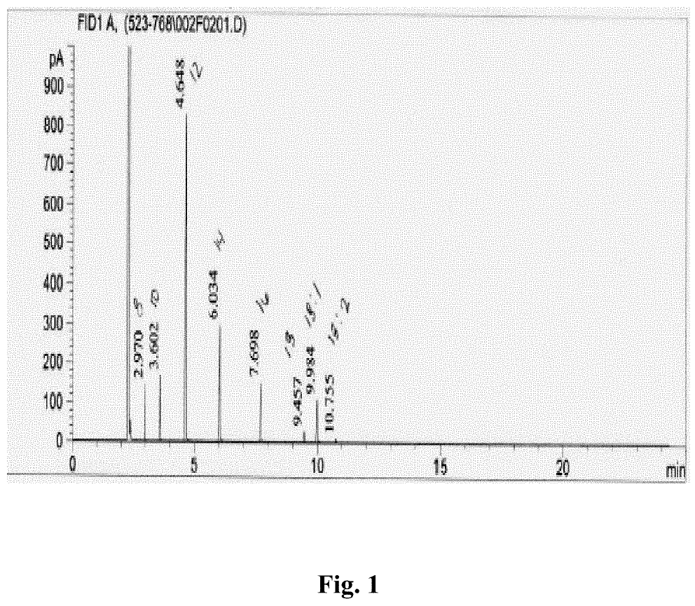

Relative ratios of fatty acids in coconut free fatty acid: GC analyses of coconut oil FFA showed at least 8 compounds that were further identified by comparisons of retention times and mass spectra of the synthetic standards as caprylic acid, capric acid, lauric acid, myristic acid, palmitic acid, stearic acid, oleic acid, and linoleic acid, respectively (FIG. 1 and Table 1). Among them, lauric acid dominated with over 52% of the total acid contents. These results are similar to those reported from previous analyses in oleochemical industry worldwide, with high lauric oil content of approximately 50%. Coconut oil is an important feedstock material of the oleochemical industry, and considered as a major commercial source of lauric acid. Lauric acid is a highly desirable material because of the importance of the lauric fraction especially in the manufacture of soaps and detergents.

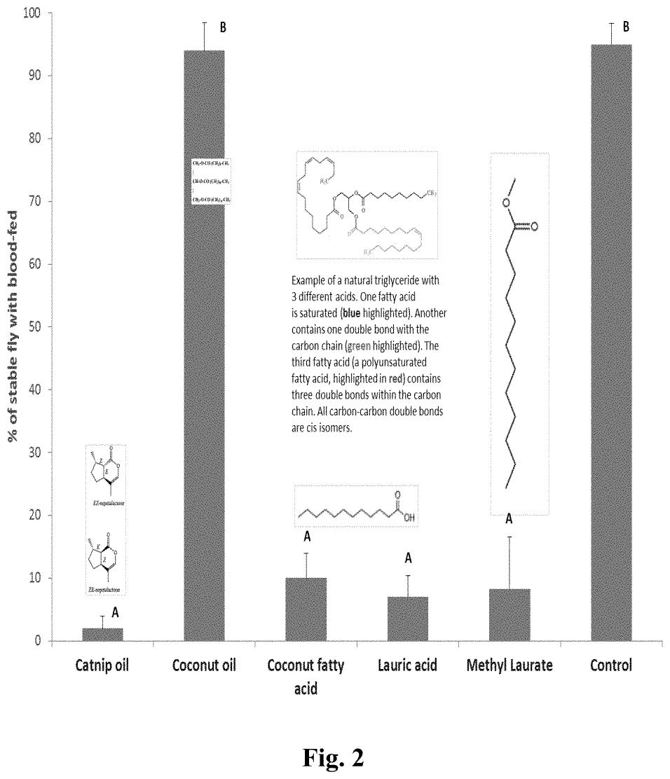

Comparisons of coconut oil, coconut FFA, and lauric acid against stable fly blood-feeding: Using our modified stable fly laboratory repellent bioassay, we tested coconut oil, coconut FFA and its major compositional compound, lauric acid, for their repellency against stable flies. Surprisingly only coconut FFA and lauric acid showed strong repellency against stable flies, with 90% repellency while tested at the 20 mg dosage (FIG. 2; df=5,244; F=107.1 P<0.0001). The effectiveness was similar to the level from one of the previously reported stable fly repellent, catnip oil. Coconut oil in contrast showed no repellency at all. Surprisingly, the methyl ester derivative of lauric acid (methyl laurate) not only showed similar repellency as found in its acid, and also with a relative strong toxicity (mean LD ranging from 11-20 mins), while lauric acid showed no toxic effect. Without being bound by theory, the non-repellency found from coconut oil is probably due to the covalent bonds between the fatty acids and glycerol (commonly known as glycerin) via ester linkages (mono-, di, and tri-glycerides) and also its high vapor pressure.

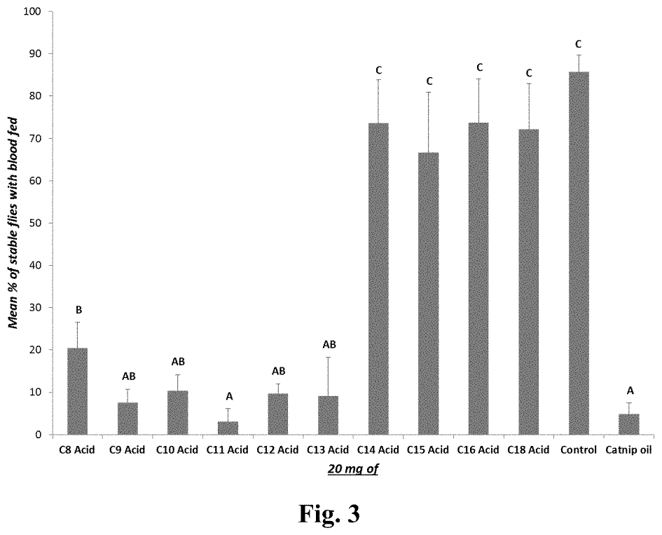

Comparisons of repellency against stable flies from compositional compounds (C₈ to C₁₈ acids) from coconut FFA: Acids from C₁₄ to C₁₈ surprisingly showed no repellency against stable flies (FIG. 3). Significant repellency was clearly found from even carbon chain length free fatty acids from C₈ to C₁₂ with 90% of repellency, except from C₈ acid with >80% repellency observed (df=11,140; F=32.6 P<0.0005). Odd carbon chain length fatty acids (C₁₁₋₁₅) from Sigma Inc. were also tested and C₉, C₁₁ and C₁₃ acids displayed the strongest repellency, which was equally as effective as catnip oil (a known strong biting fly repellent as a positive control). However, those odd carbon chain length acids do not commonly occur in nature.

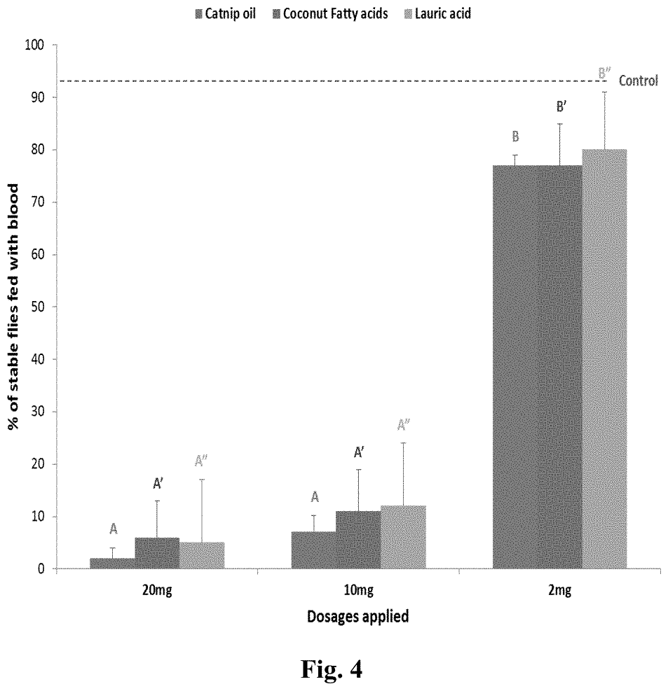

Dose response curves of repellency against stable flies from coconut FFA, lauric acid and catnip oil: We further compared the repellent efficacy against stable fly blood feeding from three doses surprisingly showing over 90% repellency from all three at a 20 mg dosage (FIG. 4; df=2.75; F=29-52 P<0.001). While testing at the dosage of 10 mg, there were surprisingly still over 85% repellency observed. No repellency was observed when the dose was reduced to 2 mg. No significant differences in the least repellency concentrations were found among the three repellent candidates, with average 13 mg of both coconut FFA and lauric acid was needed, compared to 7.3 mg for catnip oil to achieve 90% repellency (Table 2), although they were not statistically different (df=2.58; F=2.6 P>0.05).

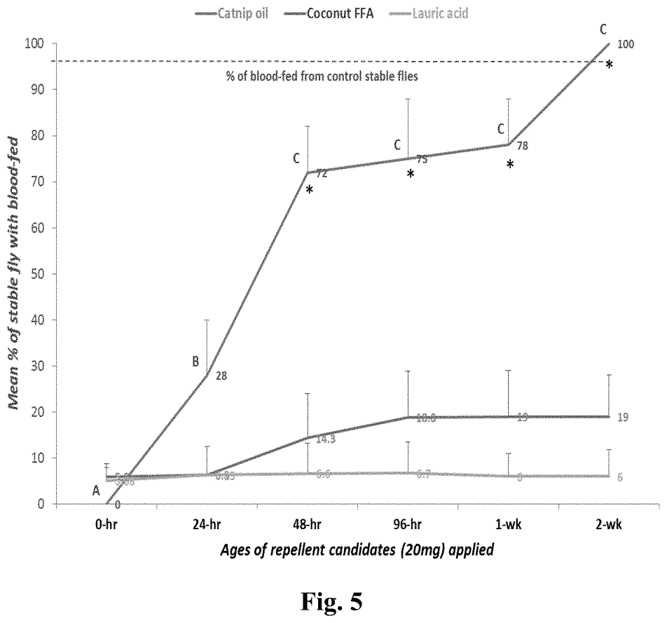

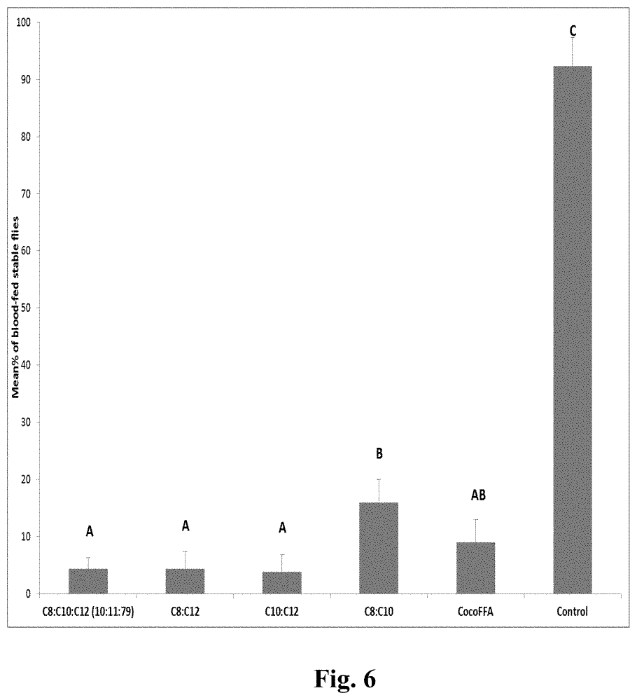

The repellent longevity tests against stable flies from coconut FFA, lauric acid and catnip oil: Surprisingly, over a 2-week effective repellency was observed from both coconut FFA and its major compositional compound, lauric acid (FIG. 5). Even though only 80% repellency from coconut FFA was observed, relative to 94% from the pure lauric acid, they were not significant different (t=1.7-2.0, P>0.05). In addition, coconut FFA only contained half of the amount of lauric acid with ˜53%. In contrast, catnip oil's repellent efficacy surprisingly only lasted for one day, followed by less than 30% repellency after the second day. Without being bound by theory, the relative short effectiveness in catnip oil is probably due to its high volatility or low vapor pressure.

Differences in repellent efficacy among blends of different chain length fatty acids: We also discovered from our laboratory bioassays that different combinations of ingredient fatty acids identified from coconut oil had different effectiveness against stable fly blood feeding (FIG. 6). It seemed that stronger repellency found surprisingly from a three component blend (10:11:79 ratio of C8:C10:C12 acids, this ratio reflects the ratio found from the natural coconut FFA) and two 2-component blends (about 1:8 ratios) with C₁₂ acid, compared to the 2-component blend (about 1:1) with short chain length acids (C₁₀ and C₈). However, all tested different blend ratios of acids were surprisingly strong repellents (<15% blood fed) relative to the control (>90% blood-fed).

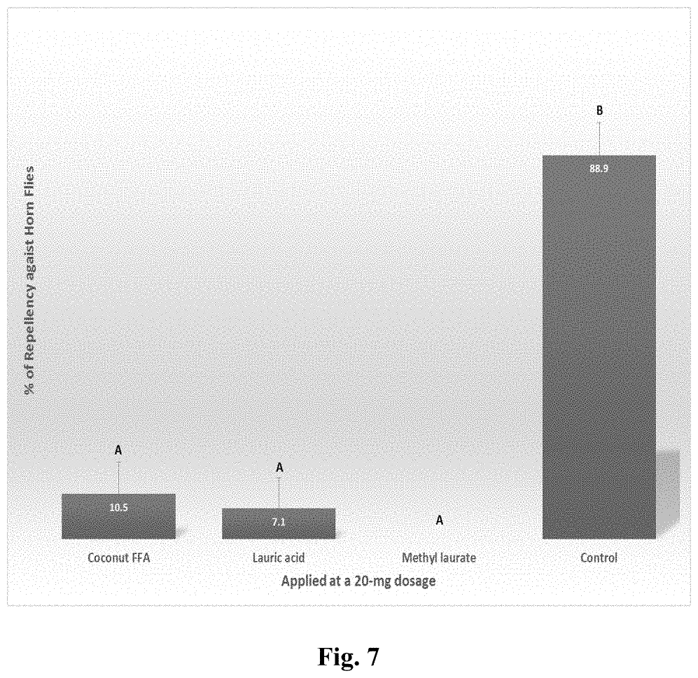

Comparisons of coconut FFA, methyl laurate, and lauric acid against horn fly blood-feeding: We also tested coconut FFA and its major compositional compound, lauric acid, for their repellency against horn flies. Coconut FFA and lauric acid surprisingly showed strong repellency against horn flies with over 90% repellency when tested at the 20 mg dosage (FIG. 7; df=3.62; F=41.5 P<0.0001).

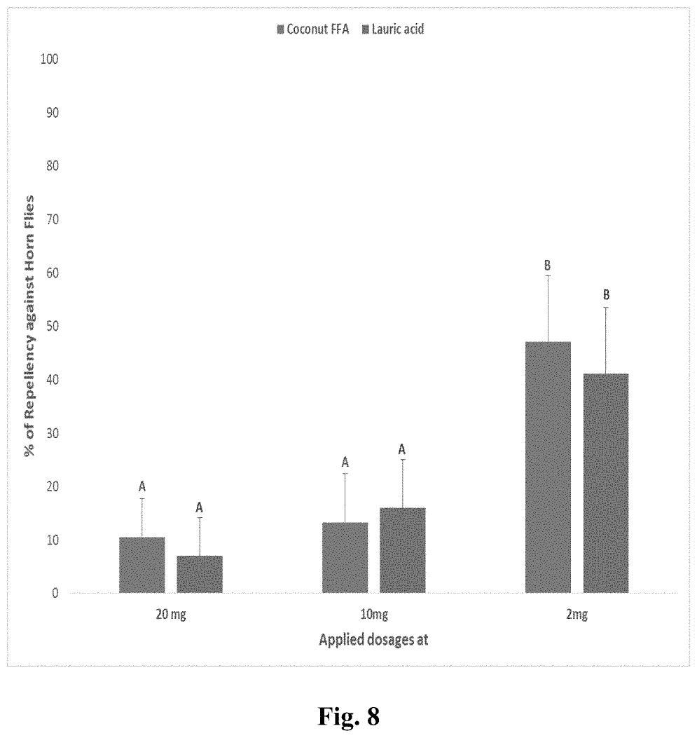

Dose response curves of repellency against horn flies from coconut FFA and lauric acid: Dose-response tests of coconut FFA and lauric acid were further tested surprisingly showing the repellent efficacy against horn fly blood feeding with over 90% repellency at a 20 mg dosage (FIG. 8; df=2.46-48; F=4.08-4.38 P<0.05). While testing at the dosage of 10 mg, surprisingly over 85% repellency was observed. A 50% repellency was shown when the dose was reduced to 2 mg. No significant differences in the least repellency concentrations were found among the two repellent candidates, with average 7 mg of both coconut FFA and lauric acid was needed.

Economic analyses of coconut FFA production cost and its practicality in field application: To our knowledge, Southeast Asian countries, such as Malaysia and Indonesia, are the major producers for coconut oil productions. In 2014, Malaysia and Indonesia produced about 30 million metric tons of crude coconut oil. Since 2010, the price of this oil in the international market has been reduced significantly to less than $1155 per metric ton. In the US, coconut oil can be purchased for less than $1.5 per kg, bulk price. From previous field trials we sprayed cattle with catnip oil as a repellent; we measured the mean areas of each cattle for repellent consumption, which was about 24,745 cm². Based on our laboratory assay, 20 mg applied on a 4×5 cm area that provided a 2-week effectiveness in repellency. The estimated cost for spray (raw material use) for each cattle is about 3.8 cents. This cost can be easily accepted by livestock producers, which have spent over $10 per cattle in using fly control products, such as ear tags, insecticides, etc.

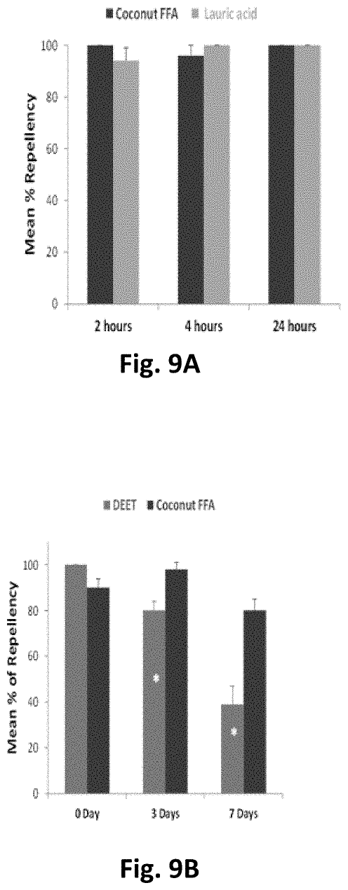

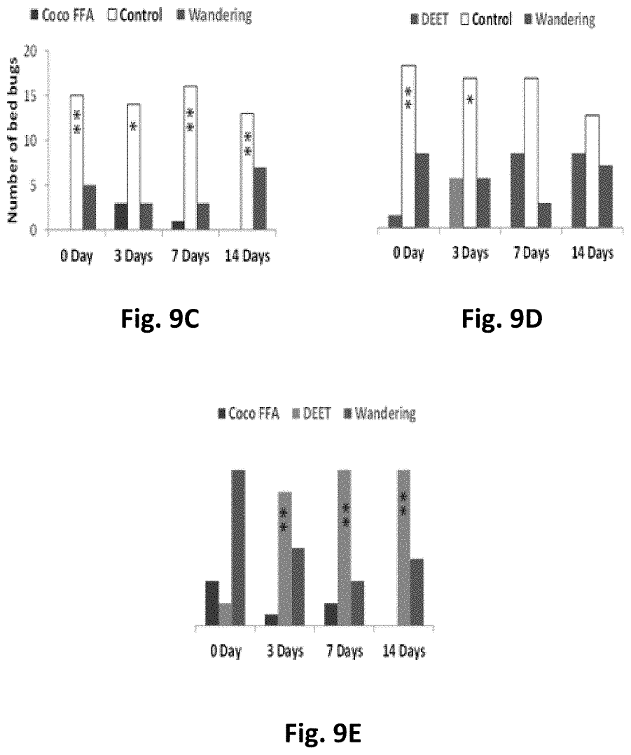

Bed bugs: Laboratory bioassays (FIG. 9A, FIG. 9B, FIG. 9C, FIG. 9E) surprisingly showed that week-long repellency from coconut oil fatty acids to bed bugs (Cimex letularius) was demonstrated. Results from the petri-dish assay showed that no significant differences in repellency observed between coconut fatty acids and its major compound, lauric acid within 24 hours period (FIG. 9A). While comparing the longevity of repellent efficiency between DEET and coconut fatty acids, significant stronger repellency was found from coconut fatty acid even at the 7th day after application, with over 80% remaining; in contrast, below 40% of repellency was observed after 7 days from DEET (FIG. 9B, P<0.05). A second lab bioassay designed to test bed bug response to choose among tents (harborages) treated with coconut fatty acids, DEET or a control (hexane) showed an increase to choose of choice of DEET after 3 days, while the coconut fatty acids treated tents showed strong repellency for up to 2 weeks (FIG. 9C-9E, * P<0.05; ** P<0.001). Bed bugs chose to rest on control tents (hexane-treated) when given a choice of coconut FFA-treated tent (FIG. 9C). This effect lasted on tents treated 14d earlier. Initially bed bugs chose control tents over DEET-treated tents (0d and 3d), but this effect was no longer significant at 7d and 14d (FIG. 9D). At 0d bed bugs did not discriminate between DEET and Coconut FFA, preferring to wander in the test arena (FIG. 9E); however from 3d to 14d after tent treatment bed bugs chose to rest on DEET-treated over Coconut FFA-treated tents.

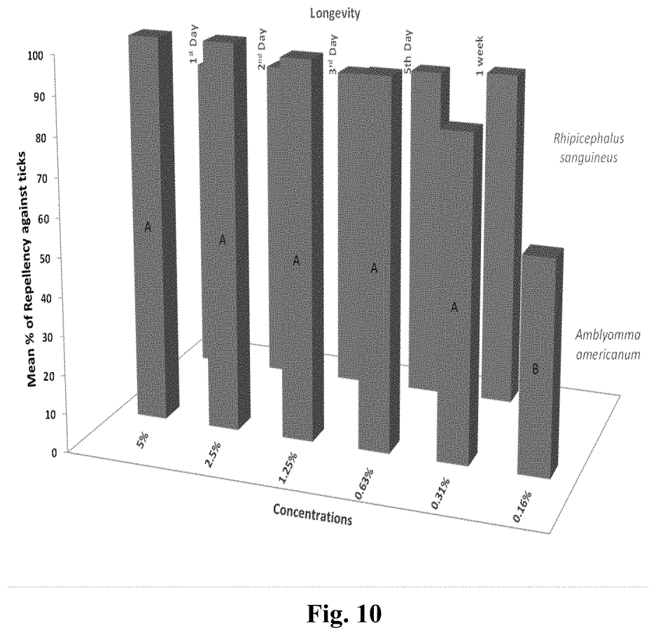

Ticks: Strong repellency was also shown to two tick species from coconut fatty acids (FIG. 10; df=5.20; F=4.71, P<0.01). For the lone star tick (A. americanum) surprisingly over 95% of repellency was observed while tested concentrations above 0.625% (0.05 mg/cm²) in fingertip assay. Using petri dish bioassay, we surprisingly found that coconut oil fatty acids provided protection for up to 7 days with repellency demonstrated between 84% and 88% to brown dog ticks (R. sanguineus).

Mosquitoes: When testing repellency of coconut oil fatty acids on yellow fever mosquitoes, a minimum required dose for effective repelling mosquitoes at 0.5 mg/cm² was needed (Table 4). A further test demonstrated that coconut oil fatty acids at 25% (0.42 mg/cm²) provided over 93% of protection against yellow fever mosquitoes, while 73% of protection was observed from the same concentration containing its major compositional compound, lauric acid (Table 5).

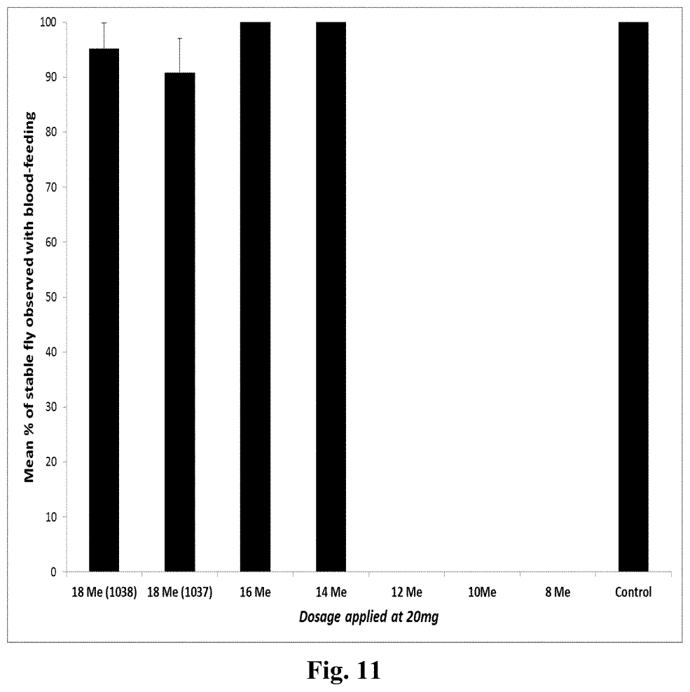

The converted methyl ester of lauric acid surprisingly showed almost 100% of repellency, from our initial bioassays. Therefore, we further tested methyl esters of C8-C16 fatty acids with the purity around 96-99% and 18:1 (1037 and 1038), methyl oleate (Table 6). Surprisingly, all methyl esters from C8-C12 not only showed strong repellency against stable flies, but also act as a strong toxicant (FIG. 11-14).

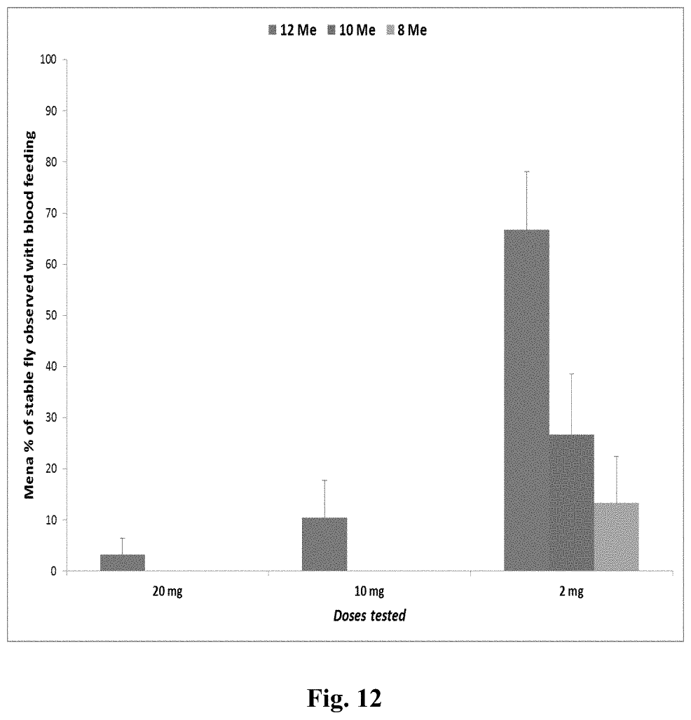

In FIG. 11, repellent activity tests were conducted under the laboratory conditions (22° C., 50% RH), 48-hr starved stable flies were used, and a total of at least 5 replicates were accumulated. At a tested dosage at 20 mg, 100% repellency was surprisingly observed from C8 Me, C10 Me and C12 Me. Methyl esters from C14-C16 and C18 (methyl oleate) surprisingly did not showed significant repellency relative to controls (FIG. 11). Dose response (FIG. 12) indicated that while testing doses >10 mg more than 90% repellency was surprisingly observed from all active methyl esters (C8-C12). Octanoate ester (C8 Me) showed the strongest repellency when tested at 2 mg dosage.

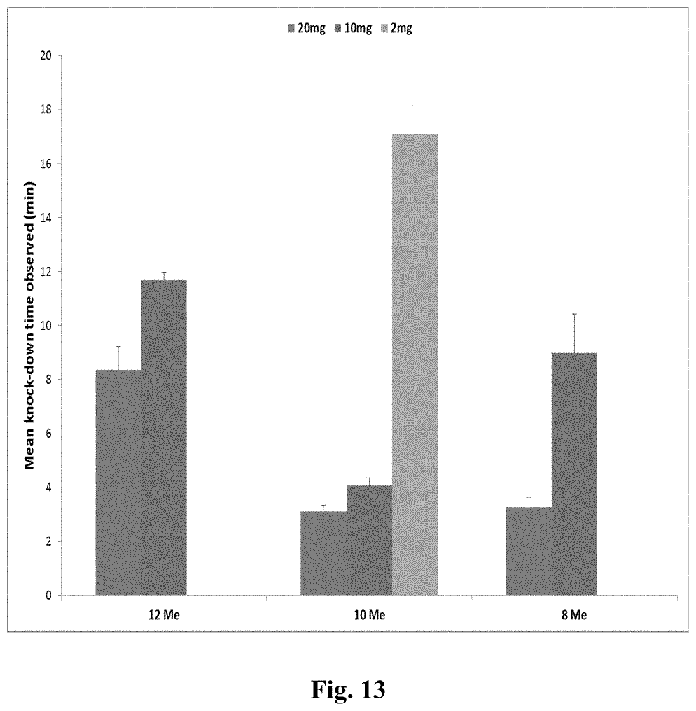

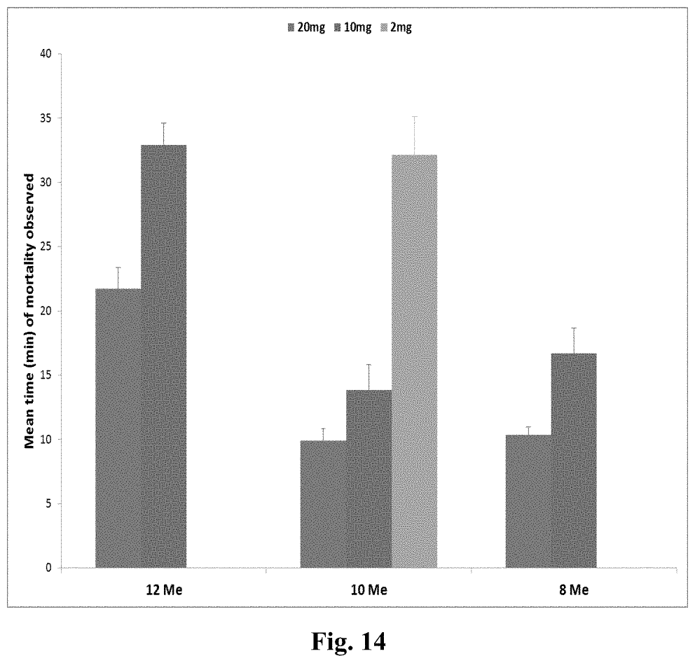

During the course of the repellent assay, we also surprisingly observed that the testing flies were knocked down in the testing apparatus and some were dead after periods of time after exposure. FIG. 13 shows the mean knock-down time from the three doses of C8-C12 methyl esters. While testing with 20 mg and 10 mg doses, all three methyl esters showed some toxic activity against stable flies, but significantly shorter knock-down times were surprisingly observed from C8 and C10 methyl esters. However, no knock-down was observed from the lowest dose, 2 mg, from C12 and C8 esters. C10 Me ester was surprisingly the most active toxicant among all tested. Similar results were found while measured their mortality (FIG. 14). Strong mortality was surprisingly demonstrated when testing dose at 20 mg, with 10-20 mins after exposure with the three methyl esters. The C12 Me ester was the least toxic compound among all tested samples while the 10 Me ester was surprisingly capable of killing all tested stable flies within 10-15 mins.

Summary: A topical biting insect repellent with surprisingly long effectiveness up to 2 weeks was identified from hydrolyzed coconut oil with mixtures of one, two and three volatile or semi-volatile repellent organic compounds. Active ingredients for formulations are composed of homologous series of straight chain-length free fatty acids, especially C12 acid (lauric acid), as well as its analogues including the methyl ester of lauric acid (methyl laurate), salts of lauric acids, methyl-, ethyl and propyl laurate. These new natural repellents were demonstrated to surprisingly repel not only biting flies, but also ticks, bedbugs with up to 2-week longevity (the longest reported in repellent history so far) and mosquitoes. In comparison to N,N-diethyl-m-toluamide (DEET), surprisingly its repellency was significantly stronger while testing against biting flies, bed bugs and ticks. The methyl esters of C8-C12 also demonstrated as strong toxicants against stable flies, with the C10 methyl ester displaying with the strongest killing factors against stable flies (mean mortality observed almost 100%, with less than 3 mins knock-down and <10 mins to kill). This invention suggests its wide usages against multiple biting insects to protect pets, livestock, and humans.

All of the references cited herein, including U.S. Patents and U.S. Patent Application Publications, are incorporated by reference in their entirety. The following references are also incorporated by reference: Zumpt, F., The Stomoxyine Biting Flies of the World, Gustav Fisher Verlag, Stuttgart, Germany, pp 1-175 (1973); Taylor, D. B., et al., Med. and Vet. Entomol., 49: 198-209 (2012); Cilek, J. E., and G. L. Greene, J. of Econ. Entomol., 87: 275-279 (1994); Marcon, P. C. R. G., et al., J. Econ. Entomol., 90: 293-298 (1997); Somme, L., J. Econ. Entomol., 51: 599-601 (1985); Pitzer, J. B., et al., J. Econ. Entomol., 103: 2258-2263 (2010); Isman, M. B., Annual Review of Entomology, 51: 45-66. (2006); Tennessee Dairy Cattle Pest Control Profile (2007); Insect Control for Beef Cattle (2016, University of Kentucky, Extension Service); Recent Developments in Invertebrate Repellents (ACS Division of Agrochemicals, 2011).

Thus, in view of the above, there is described (in part) the following:

A method for repelling or killing blood-sucking insects and biting insects, ticks and mites, said method comprising (or consisting essentially of or consisting of) treating an object or area with a composition comprising (or consisting essentially of or consisting of) a blood-sucking insects, biting insects, ticks, and mites repelling or killing effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid, and mixtures thereof, and optionally a carrier.

The above method, said method comprising (or consisting essentially of or consisting of) treating an object or area with a composition comprising (or consisting essentially of or consisting of) a blood-sucking insects, biting insects, ticks, and mites repelling effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid, and mixtures thereof, and optionally a carrier.

The above method, said method comprising (or consisting essentially of or consisting of) treating an object or area with a composition comprising (or consisting essentially of or consisting of) a blood-sucking insects, biting insects, ticks, and mites killing effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid, and mixtures thereof, and optionally a carrier. The above method, wherein said composition comprises (or consists essentially of or consists of) at least one compound selected from the group consisting of a methyl ester of a C₈ or C₁₀ or C₁₂, and optionally a carrier.

The above method, wherein said insects are selected from the group consisting of stable flies, horn flies, bedbugs, mosquitoes, and mixtures thereof.

The above method, wherein said insects are selected from the group consisting of stable flies, horn flies, and mixtures thereof.

The above method, said method comprising (or consisting essentially of or consisting of) treating an object or area with a composition comprising (or consisting essentially of or consisting of) a blood-sucking insects, biting insects, ticks, and mites repelling or killing effective amount of at least two compounds selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid, and mixtures thereof, and optionally a carrier.

The above method, wherein said method comprising (or consisting essentially of or consisting of) treating an object or area with a composition comprising (or consisting essentially of or consisting of) a blood-sucking insects, biting insects, ticks and mites repelling or killing effective amount of at least one compound selected from the group consisting of lauric acid, methyl laurate, and mixtures thereof, and optionally a carrier.

The above method, wherein said composition comprises (or consists essentially of or consists of) coconut free fatty acids.

The above method, wherein said insects are selected from the group consisting of stable flies Stomoxys calcitran, horn flies Haematobia irritans, bedbugs, mosquitoes, and mixtures thereof.

A method for repelling blood-sucking insects and biting insects, ticks and mites, said method comprising (or consisting essentially of or consisting of) treating an object or area with a composition comprising (or consisting essentially of or consisting of) a blood-sucking insects, biting insects, ticks, and mites repelling effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid, and mixtures thereof, and optionally a carrier.

A method for blood-sucking insects and biting insects, ticks and mites, said method comprising (or consisting essentially of or consisting of) treating an object or area with a composition comprising (or consisting essentially of or consisting of) a blood-sucking insects, biting insects, ticks, and mites killing effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid, and mixtures thereof, and optionally a carrier.

The above method, wherein said compound is a C₈ straight chain free fatty acid. The above method, wherein said compound is not a C₈ straight chain free fatty acid. The above method, wherein said compound is a C₉ straight chain free fatty acid. The above method, wherein said compound is not a C₉ straight chain free fatty acid. The above method, wherein said compound is a C₁₀ straight chain free fatty acid. The above method, wherein said compound is not a C₁₀ straight chain free fatty acid. The above method, wherein said compound is a C₁₁ straight chain free fatty acid. The above method, wherein said compound is not a C₁₁ straight chain free fatty acid. The above method, wherein said compound is a C₁₂ straight chain free fatty acid. The above method, wherein said compound is not a C₁₂ straight chain free fatty acid. The above method, wherein said compound is a C₁₃ straight chain free fatty acid. The above method, wherein said compound is not a C₁₃ straight chain free fatty acid. The above method, wherein said compound is a C₈ branched chain free fatty acid. The above method, wherein said compound is not a C₈ branched chain free fatty acid. The above method, wherein said compound is a C₉ branched chain free fatty acid. The above method, wherein said compound is not a C₉ branched chain free fatty acid. The above method, wherein said compound is a C₁₀ branched chain free fatty acid. The above method, wherein said compound is not a C₁₀ branched chain free fatty acid. The above method, wherein said compound is a C₁₁ branched chain free fatty acid. The above method, wherein said compound is not a C₁₁ branched chain free fatty acid. The above method, wherein said compound is a C₁₂ branched chain free fatty acid. The above method, wherein said compound is not a C₁₂ branched chain free fatty acid. The above method, wherein said compound is a C₁₃ branched chain free fatty acid. The above method, wherein said compound is not a C₁₃ branched chain free fatty acid. The above method, wherein said compound is a methyl ester of a C₈ straight chain free fatty acid. The above method, wherein said compound is not a methyl ester of a C₈ straight chain free fatty acid. The above method, wherein said compound is a methyl ester of a C₉ straight chain free fatty acid. The above method, wherein said compound is not a methyl ester of a C₉ straight chain free fatty acid. The above method, wherein said compound is a methyl ester of a C₁₀ straight chain free fatty acid. The above method, wherein said compound is not a methyl ester of a C₁₀ straight chain free fatty acid. The above method, wherein said compound is a methyl ester of a C₁₁ straight chain free fatty acid. The above method, wherein said compound is not a methyl ester of a C₁₁ straight chain free fatty acid. The above method, wherein said compound is a methyl ester of a C₁₂ straight chain free fatty acid. The above method, wherein said compound is not a methyl ester of a C₁₂ straight chain free fatty acid. The above method, wherein said compound is a methyl ester of a C₁₃ straight chain free fatty acid. The above method, wherein said compound is not a methyl ester of a C₁₃ straight chain free fatty acid. The above method, wherein said compound is a methyl ester of a C₈ branched chain free fatty acid. The above method, wherein said compound is not a methyl ester of a C₈ branched chain free fatty acid. The above method, wherein said compound is a methyl ester of a C₉ branched chain free fatty acid. The above method, wherein said compound is not a methyl ester of a C₉ branched chain free fatty acid. The above method, wherein said compound is a methyl ester of a C₁₀ branched chain free fatty acid. The above method, wherein said compound is not a methyl ester of a C₁₀ branched chain free fatty acid. The above method, wherein said compound is a methyl ester of a C₁₁ branched chain free fatty acid. The above method, wherein said compound is not a methyl ester of a C₁₁ branched chain free fatty acid. The above method, wherein said compound is a methyl ester of a C₁₂ branched chain free fatty acid. The above method, wherein said compound is not a methyl ester of a C₁₂ branched chain free fatty acid. The above method, wherein said compound is a methyl ester of a C₁₃ branched chain free fatty acid. The above method, wherein said compound is not a methyl ester of a C₁₃ branched chain free fatty acid. The above method, wherein said compound is a ethyl ester of a C₈ straight chain free fatty acid. The above method, wherein said compound is not a ethyl ester of a C₈ straight chain free fatty acid. The above method, wherein said compound is a ethyl ester of a C₉ straight chain free fatty acid. The above method, wherein said compound is not a ethyl ester of a C₉ straight chain free fatty acid. The above method, wherein said compound is a ethyl ester of a C₁₀ straight chain free fatty acid. The above method, wherein said compound is not a ethyl ester of a C₁₀ straight chain free fatty acid. The above method, wherein said compound is a ethyl ester of a C₁₁ straight chain free fatty acid. The above method, wherein said compound is not a ethyl ester of a C₁₁ straight chain free fatty acid. The above method, wherein said compound is a ethyl ester of a C₁₂ straight chain free fatty acid. The above method, wherein said compound is not a ethyl ester of a C₁₂ straight chain free fatty acid. The above method, wherein said compound is a ethyl ester of a C₁₃ straight chain free fatty acid. The above method, wherein said compound is not a ethyl ester of a C₁₃ straight chain free fatty acid. The above method, wherein said compound is a ethyl ester of a C₈ branched chain free fatty acid. The above method, wherein said compound is not a ethyl ester of a C₈ branched chain free fatty acid. The above method, wherein said compound is a ethyl ester of a C₉ branched chain free fatty acid. The above method, wherein said compound is not a ethyl ester of a C₉ branched chain free fatty acid. The above method, wherein said compound is a ethyl ester of a C₁₀ branched chain free fatty acid. The above method, wherein said compound is not a ethyl ester of a C₁₀ branched chain free fatty acid. The above method, wherein said compound is a ethyl ester of a C₁₁ branched chain free fatty acid. The above method, wherein said compound is not a ethyl ester of a C₁₁ branched chain free fatty acid. The above method, wherein said compound is a ethyl ester of a C₁₂ branched chain free fatty acid. The above method, wherein said compound is not a ethyl ester of a C₁₂ branched chain free fatty acid. The above method, wherein said compound is a ethyl ester of a C₁₃ branched chain free fatty acid. The above method, wherein said compound is not a ethyl ester of a C₁₃ branched chain free fatty acid. The above method, wherein said compound is a propyl ester of a C₈ straight chain free fatty acid. The above method, wherein said compound is not a propyl ester of a C₈ straight chain free fatty acid. The above method, wherein said compound is a propyl ester of a C₉ straight chain free fatty acid. The above method, wherein said compound is not a propyl ester of a C₉ straight chain free fatty acid. The above method, wherein said compound is a propyl ester of a C₁₀ straight chain free fatty acid. The above method, wherein said compound is not a propyl ester of a C₁₀ straight chain free fatty acid. The above method, wherein said compound is a propyl ester of a C₁₁ straight chain free fatty acid. The above method, wherein said compound is not a propyl ester of a C₁₁ straight chain free fatty acid. The above method, wherein said compound is a propyl ester of a C₁₂ straight chain free fatty acid. The above method, wherein said compound is not a propyl ester of a C₁₂ straight chain free fatty acid. The above method, wherein said compound is a propyl ester of a C₁₃ straight chain free fatty acid. The above method, wherein said compound is not a propyl ester of a C₁₃ straight chain free fatty acid. The above method, wherein said compound is a propyl ester of a C₈ branched chain free fatty acid. The above method, wherein said compound is not a propyl ester of a C₈ branched chain free fatty acid. The above method, wherein said compound is a propyl ester of a C₉ branched chain free fatty acid. The above method, wherein said compound is not a propyl ester of a C₉ branched chain free fatty acid. The above method, wherein said compound is a propyl ester of a C₁₀ branched chain free fatty acid. The above method, wherein said compound is not a propyl ester of a C₁₀ branched chain free fatty acid. The above method, wherein said compound is a propyl ester of a C₁₁ branched chain free fatty acid. The above method, wherein said compound is not a propyl ester of a C₁₁ branched chain free fatty acid. The above method, wherein said compound is a propyl ester of a C₁₂ branched chain free fatty acid. The above method, wherein said compound is not a propyl ester of a C₁₂ branched chain free fatty acid. The above method, wherein said compound is a propyl ester of a C₁₃ branched chain free fatty acid. The above method, wherein said compound is not a propyl ester of a C₁₃ branched chain free fatty acid. The above method, wherein said compound is an isopropyl ester of a C₈ straight chain free fatty acid. The above method, wherein said compound is not an isopropyl ester of a C₈ straight chain free fatty acid. The above method, wherein said compound is an isopropyl ester of a C₉ straight chain free fatty acid. The above method, wherein said compound is not an isopropyl ester of a C₉ straight chain free fatty acid. The above method, wherein said compound is an isopropyl ester of a C₁₀ straight chain free fatty acid. The above method, wherein said compound is not an isopropyl ester of a C₁₀ straight chain free fatty acid. The above method, wherein said compound is an isopropyl ester of a C₁₁ straight chain free fatty acid. The above method, wherein said compound is not an isopropyl ester of a C₁₁ straight chain free fatty acid. The above method, wherein said compound is an isopropyl ester of a C₁₂ straight chain free fatty acid. The above method, wherein said compound is not an isopropyl ester of a C₁₂ straight chain free fatty acid. The above method, wherein said compound is an isopropyl ester of a C₁₃ straight chain free fatty acid. The above method, wherein said compound is not an isopropyl ester of a C₁₃ straight chain free fatty acid. The above method, wherein said compound is an isopropyl ester of a C₈ branched chain free fatty acid. The above method, wherein said compound is not an isopropyl ester of a C₈ branched chain free fatty acid. The above method, wherein said compound is an isopropyl ester of a C₉ branched chain free fatty acid. The above method, wherein said compound is not an isopropyl ester of a C₉ branched chain free fatty acid. The above method, wherein said compound is an isopropyl ester of a C₁₀ branched chain free fatty acid. The above method, wherein said compound is not an isopropyl ester of a C₁₀ branched chain free fatty acid. The above method, wherein said compound is an isopropyl ester of a C₁₁ branched chain free fatty acid. The above method, wherein said compound is not an isopropyl ester of a C₁₁ branched chain free fatty acid. The above method, wherein said compound is an isopropyl ester of a C₁₂ branched chain free fatty acid. The above method, wherein said compound is not an isopropyl ester of a C₁₂ branched chain free fatty acid. The above method, wherein said compound is an isopropyl ester of a C₁₃ branched chain free fatty acid. The above method, wherein said compound is not an isopropyl ester of a C₁₃ branched chain free fatty acid. The above method, wherein said compound is a 2-ethyl hexyl ester of a C₈ straight chain free fatty acid. The above method, wherein said compound is not a 2-ethyl hexyl ester of a C₈ straight chain free fatty acid. The above method, wherein said compound is a 2-ethyl hexyl ester of a C₉ straight chain free fatty acid. The above method, wherein said compound is not a 2-ethyl hexyl ester of a C₉ straight chain free fatty acid. The above method, wherein said compound is a 2-ethyl hexyl ester of a C₁₀ straight chain free fatty acid. The above method, wherein said compound is not a 2-ethyl hexyl ester of a C₁₀ straight chain free fatty acid. The above method, wherein said compound is a 2-ethyl hexyl ester of a C₁₁ straight chain free fatty acid. The above method, wherein said compound is not a 2-ethyl hexyl ester of a C₁₁ straight chain free fatty acid. The above method, wherein said compound is a 2-ethyl hexyl ester of a C₁₂ straight chain free fatty acid. The above method, wherein said compound is not a 2-ethyl hexyl ester of a C₁₂ straight chain free fatty acid. The above method, wherein said compound is a 2-ethyl hexyl ester of a C₁₃ straight chain free fatty acid. The above method, wherein said compound is not a 2-ethyl hexyl ester of a C₁₃ straight chain free fatty acid. The above method, wherein said compound is a 2-ethyl hexyl ester of a C₈ branched chain free fatty acid. The above method, wherein said compound is not a 2-ethyl hexyl ester of a C₈ branched chain free fatty acid. The above method, wherein said compound is a 2-ethyl hexyl ester of a C₉ branched chain free fatty acid. The above method, wherein said compound is not a 2-ethyl hexyl ester of a C₉ branched chain free fatty acid. The above method, wherein said compound is a 2-ethyl hexyl ester of a C₁₀ branched chain free fatty acid. The above method, wherein said compound is not a 2-ethyl hexyl ester of a C₁₀ branched chain free fatty acid. The above method, wherein said compound is a 2-ethyl hexyl ester of a C₁₁ branched chain free fatty acid. The above method, wherein said compound is not a 2-ethyl hexyl ester of a C₁₁ branched chain free fatty acid. The above method, wherein said compound is a 2-ethyl hexyl ester of a C₁₂ branched chain free fatty acid. The above method, wherein said compound is not a 2-ethyl hexyl ester of a C₁₂ branched chain free fatty acid. The above method, wherein said compound is a 2-ethyl hexyl ester of a C₁₃ branched chain free fatty acid. The above method, wherein said compound is not a 2-ethyl hexyl ester of a C₁₃ branched chain free fatty acid. The above method, wherein said compound is a salt of a C₈ straight chain free fatty acid. The above method, wherein said compound is not a salt of a C₈ straight chain free fatty acid. The above method, wherein said compound is a salt of a C₉ straight chain free fatty acid. The above method, wherein said compound is not a salt of a C₉ straight chain free fatty acid. The above method, wherein said compound is a salt of a C₁₀ straight chain free fatty acid. The above method, wherein said compound is not a salt of a C₁₀ straight chain free fatty acid. The above method, wherein said compound is a salt of a C₁₁ straight chain free fatty acid. The above method, wherein said compound is not a salt of a C₁₁ straight chain free fatty acid. The above method, wherein said compound is a salt of a C₁₂ straight chain free fatty acid. The above method, wherein said compound is not a salt of a C₁₂ straight chain free fatty acid. The above method, wherein said compound is a salt of a C₁₃ straight chain free fatty acid. The above method, wherein said compound is not a salt of a C₁₃ straight chain free fatty acid. The above method, wherein said compound is a salt of a C₈ branched chain free fatty acid. The above method, wherein said compound is not a salt of a C₈ branched chain free fatty acid. The above method, wherein said compound is a salt of a C₉ branched chain free fatty acid. The above method, wherein said compound is not a salt of a C₉ branched chain free fatty acid. The above method, wherein said compound is a salt of a C₁₀ branched chain free fatty acid. The above method, wherein said compound is not a salt of a C₁₀ branched chain free fatty acid. The above method, wherein said compound is a salt of a C₁₁ branched chain free fatty acid. The above method, wherein said compound is not a salt of a C₁₁ branched chain free fatty acid. The above method, wherein said compound is a salt of a C₁₂ branched chain free fatty acid. The above method, wherein said compound is not a salt of a C₁₂ branched chain free fatty acid. The above method, wherein said compound is a salt of a C₁₃ branched chain free fatty acid. The above method, wherein said compound is not a salt of a C₁₃ branched chain free fatty acid.

The above repelling method, wherein said insects do not include mosquitoes.

The above repelling method, wherein said insects do not include Ades aegypti.

The above killing method, wherein said insects do not include mosquitoes.

The above killing method, wherein said insects do not include Ades aegypti.

The above repelling method, wherein said insects do not include hard ticks.

The above repelling method, wherein said insects do not include hard ticks and the composition does not include lauric acid.

The above repelling method, wherein said insects do not include hard ticks (Ixodes ricinus).

The above repelling method, wherein said insects do not include hard ticks (Ixodes ricinus) and the composition does not include lauric acid.

A method for killing insects, said method comprising (or consisting essentially of or consisting of) treating an object or area with a composition comprising (or consisting essentially of or consisting of) an insects killing effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid, and mixtures thereof, and optionally a carrier.

A method for repelling insects, said method comprising (or consisting essentially of or consisting of) treating an object or area with a composition comprising (or consisting essentially of or consisting of) an insects repelling effective amount of at least one compound selected from the group consisting of a C₈ or C₉ or C₁₀ or C₁₁ or C₁₂ or C₁₃ straight or branched chain free fatty acid, methyl ester or ethyl ester or propyl ester or isopropyl ester or 2-ethyl hexyl ester of said acid, salts of said acid, and mixtures thereof, and optionally a carrier.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein).

The invention illustratively disclosed herein suitably may be practiced in the absence of any element (e.g., method (or process) steps or composition components) which is not specifically disclosed herein. Thus the specification includes disclosure by silence (“Negative Limitations In Patent Claims,” AIPLA Quarterly Journal, Tom Brody, 41(1): 46-47 (2013):
. . . Written support for a negative limitation may also be argued through the absence of the excluded element in the specification, known as disclosure by silence . . . .
Silence in the specification may be used to establish written description support for a negative limitation. As an example, in Ex parte Lin [No. 2009-0486, at 2, 6 (B.P.A.I. May 7, 2009)] the negative limitation was added by amendment . . . . In other words, the inventor argued an example that passively complied with the requirements of the negative limitation . . . was sufficient to provide support . . . .
This case shows that written description support for a negative limitation can be found by one or more disclosures of an embodiment that obeys what is required by the negative limitation . . . .

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Compositional chemicals identified from the coconut free
fatty acid (Acme Hardesty) analyzed via gas chromatography
after being converted to their methyl esters

| | Relative amount (%) |
|---|---|
| Caprylic acid (C8) | 6.85 ± 0.03 |
| Capric acid (C10) | 7.33 ± 0.02 |
| Lauric acid (C12) | 52.68 ± 0.11 |
| Myristic acid (C14) | 17.14 ± 0.04 |
| Palmitic acid (C16) | 8.44 ± 0.03 |
| Stearic acid (C18) | 1.29 ± 0.01 |
| Oleic acid (C18:1) | 6.02 ± 0.10 |
| Linoleic acid (C18:2) | 0.34 ± 0.01 |

TABLE 2
Comparisons of the least repellency concentrations
(LR₅₀ and LR₉₀ at mg/24 cm²) of coconut free fatty
acids and its major constituent (lauric acid)

| | LR₅₀ (95% C.I.) | LR₉₀ (95%, C.I.) |
|---|---|---|
| Coconut fatty acids | 3.98 (1.91-6.39) | 13.90 (8.47-40.39) |
| Lauric acid | 3.69 (3.23-6.53) | 13.61 (9.11-32.59) |

TABLE 3
Estimated costs for raw repellent materials
used for developing sprayable formulations

| | |
|---|---|
| Mean areas of cattle for spray per | 24,745.00 |
| animal including body and 4 legs (cm²) | |
| Costs of natural product raw material ($/mg) | |
| Lauric acid from coconut FFA | 0.00000366 |
| Methyl laurate (via | 0.0000356 |
| transesterification of coconut fat) | |
| Estimated costs per animal per application | |
| Lauric acid (C₁₂:Acid) | $ 0.09/animal application |
| | (whole body spray) |
| Methyl laurate (C₁₂:Me) | $0.88/per animal |
| | application (whole |
| | body spray) |

These estimates were based on the most effective dose at 1 mg/cm², which provides over 2-week effective (>80%) repellency in laboratory assay. Estimated prices are based on US market, $726/Drum for coconut FFA from ACME HARDESTY Oleochemicals; methyl laurate from Alibaba at $5/kg Sigma Aldrich @$321 for 9 kg.

TABLE 4
Minimum effective dosage (mg/cm²) of coconut free fatty acids required
for biting protection against Aedes aegypti, N = 3-5)

| | Dosage required |
|---|---|
| Coconut fatty acids | 0.500 ± 0.125 |
| Lauric acid | 0.750 ± 0.000 |
| DEET | 0.047 ± 0.000 |

TABLE 5
Comparisons of biting protection (%) among different doses
of coconut fatty acids, lauric acid and DEET against Aedes aegypti
(arm-in-cage assay at 1^{st} hour, N = 3)

| | 6.25% | 12.50% | 25% | 50% |
|---|---|---|---|---|
| Coconut fatty acids | 67 ± 6 | 67 ± 6 | 93 ± 7 | 87 ± 6 |
| Lauric acid | 20 ± 0 | 20 ± 0 | 74 ± 6 | 60 ± 11 |
| DEET | 58-88* | 77-97* | ≈93* | not tested |

| | |
|---|---|
| Control | 27 ± 7 |

TABLE 6

| | 19778-1032, | 19778-1033, | 19778-1034, | 19778-1035, | 19778-1037, Methyl | 19778-1038, |
|---|---|---|---|---|---|---|
| | Methyl | Methyl | Methyl | Methyl | octadecenoate, | Methyl |
| | octanoate | decanoate | tetradecanoate | hexadecanoate | Technical Grade | octadecenoate |
| | C8:0 | C10:0 | C14:0 | C16:0 | C18:1 | C18:1 |
| | Ave Normalized | Ave Normalized | Ave Normalized | Ave Normalized | Ave Normalized | Ave Normalized |
| F.A. | % FA | % FA | % FA | % FA | % FA | % FA |
| 8 Me | 99+ | 0 | 0 | 0 | 0 | 0 |
| 10 Me | 0 | 99+ | 0 | 0 | 0 | 0 |
| 12 Me | ordered from Sigma-Aldrich, 99% | | | | | |
| 14 Me | 0 | 0 | 99+ | 1 | 0 | 0 |
| 16 Me | 0 | 0 | 0 | 96 | 1 | 0 |
| 18-Me | 0 | 0 | 0 | 4 | 3 | 0 |
| 18-1 Me | 0 | 0 | 0 | 0 | 92 | 99+ |
| 18-2 Me | 0 | 0 | 0 | 0 | 4 | 0 |
| 18-3 Me | 0 | 0 | 0 | 0 | 0 | 0 |

1. A method for repelling or killing insects, said method comprising treating an object or area with a composition comprising an insects repelling or killing effective amount of at least one compound selected from the group consisting of a methyl ester of a C₈ or C₉ or C₁₀ or C₁₁ or C₁₂ or C₁₃ straight or branched chain free fatty acid, and mixtures thereof, and optionally a carrier.

2. The method of claim 1, said method comprising treating an object or area with a composition comprising an insects repelling effective amount of at least one compound selected from the group consisting of a methyl ester of a C₈ or C₉ or C₁₀ or C₁₁ or C₁₂ or C₁₃ straight or branched chain free fatty acid, and mixtures thereof, and optionally a carrier.

3. The method of claim 1, said method comprising treating an object or area with a composition comprising an insects killing effective amount of at least one compound selected from the group consisting of a methyl ester of a C₈ or C₉ or C₁₀ or C₁₁ or C₁₂ or C₁₃ straight or branched chain free fatty acid, and mixtures thereof, and optionally a carrier.

4. The method of claim 3, wherein said composition comprises at least one compound selected from the group consisting of a methyl ester of a C₈ or C₁₀ or C₁₂, and optionally a carrier.

5. The method of claim 1, wherein said insects are selected from the group consisting of stable flies, horn flies, bedbugs, mosquitoes, and mixtures thereof.

6. The method of claim 1, wherein said insects are selected from the group consisting of stable flies, horn flies, and mixtures thereof.

7. The method of claim 1, said method comprising treating an object or area with a composition comprising an insects repelling or killing effective amount of at least two compounds selected from the group consisting of a methyl ester of a C₈ or C₉ or C₁₀ or C₁₁ or C₁₂ or C₁₃ straight or branched chain free fatty acid, and mixtures thereof, and optionally a carrier.

8. (canceled)

9. (canceled)

10. The method of claim 1, wherein said insects include blood-sucking insects, biting insects, ticks and mites.
